(19) United States
(12) Patent Application Publication
(10) Pub. No.: US 2003/0130906 A1
(43) Pub. Date: Jul. 10, 2003

(54) Communication method and communication apparatus, information processing method and information processing apparatus, storage medium, and computer program

(76) Inventor: Koichi Maari, Chiba (JP)

Correspondence Address: FROMMER LAWRENCE & HAUG, 745 FIFTH AVENUE- 10TH FL., NEW YORK, NY, 10151, US

(21) Appl. No.: 10/310,371

(22) Filed: Dec. 5, 2002

(30) Foreign Application Priority Data
Dec. 6, 2001 (JP) 2001-372946

(51) Int. Cl. G06F 17/60

(52) U.S. Cl. 705/26

(57) ABSTRACT

When an IC card is placed in the vicinity of one of a television receiver, a hard disk recorder, and a personal digital assistant (PDA), a card ID stored in the IC card and the profile of each of the television receiver, the hard disk recorder and the PDA are shared, thereby forming a VPN (Virtual Private Network). When the hard disk recorder requests a content delivery server to download a content, the content delivery server sends the content in response. The content is then stored in the hard disk recorder. When the replaying of the stored content on the television receiver is requested, authentication is performed between the hard disk recorder and the television receiver based on the card ID. If the authentication is successfully completed, the content is sent to the television receiver.

### BACKGROUND OF THE INVENTION

1. Field of the Invention

The present invention relates to a communication apparatus, a communication method, an information processing method, and an information processing apparatus, a storage medium, and a computer program and, in particular, to a communication apparatus, a communication method, an information processing method, and an information processing apparatus, a storage medium, and a computer program for allowing a content to be freely used with unlimited copying restricted.

2. Description of the Related Art

Along with the advance of communication technology, delivery services of contents such as a so-called EMD (Electronic Music Distribution) are being widely used.

When a content is downloaded from an EMD system, the number of uses and the period of use of the content and the number of devices to which the content is copied are subject to limitations to protect copyright of the content. Unlimited use and copying of the content are not permitted.

The copyright of the content must be protected. However, if a limit is set, the use of the content is quite limited compared with the case in which a software program in a DVD (Digital Versatile Disc) is purchased.

In other words, when a DVD is purchased, the user may enjoy the software program on a variety of apparatuses.

### SUMMARY OF THE INVENTION

Accordingly, it is an object of the present invention to allow the user to freely use a content with unlimited copying still restricted.

A communication apparatus of the present invention includes a storage unit which stores first feature information indicating a feature of the communication apparatus, a first transmitter which transmits the first feature information stored in the storage unit to an electronic device, a receiver which receives second feature information indicating a feature of another communication apparatus, and identification information identifying the electronic device, transmitted from the electronic device, a second transmitter which is connected to the other communication apparatus based on the second feature information received from the receiver, and then transmits the first feature information to the other communication apparatus, a forming unit which stores the second feature information and then forms a virtual private network with the other communication apparatus, a requesting unit which notifies a first information processor, connected to the communication apparatus through a network, of the identification information, and requests the first information processor to transmit a predetermined content, and an acquisition unit which acquires the content transmitted by the first information processor in response to the request from the requesting unit, wherein the content acquired by the acquisition unit is shared with the other communication apparatus through the virtual private network formed by the forming unit.

The communication apparatus may further include a registering unit which registers payment destination information relating to a destination of the payment for the content in a second information processor that manages the issue of the electronic device.

The communication apparatus may further include an authentication unit for authenticating the other communication apparatus based on encryption key information transmitted from the electronic device and then received by the receiver and the identification information received by the receiver, wherein the content is shared with the other communication apparatus authenticated by the authentication unit.

A communication method of the present invention includes a step of storing first feature information indicating a feature of a communication apparatus, a first transmitting step of transmitting the first feature information stored in the storing step to an electronic device, a receiving step of receiving second feature information indicating a feature of another communication apparatus, and identification information identifying the electronic device, transmitted from the electronic device, a second transmitting step of establishing a connection with the other communication apparatus based on the second feature information received in the receiving step, and transmitting the first feature information to the other communication apparatus, a forming step of storing the second feature information and then forming a virtual private network with the other communication apparatus, a requesting step of notifying a first information processor, connected to the communication apparatus through a network, of the identification information, and requesting the first information processor to transmit a predetermined content, and an acquisition step of acquiring the content transmitted by the first information processor in response to the request in the requesting step, wherein the content acquired in the acquisition step is shared with the other communication apparatus through the virtual private network formed in the forming step.

A storage medium of the present invention stores a computer readable program. The computer readable program includes a first acquisition control step of controlling the acquisition of stored first feature information indicating a feature of a communication apparatus, a first transmission control step of controlling the transmission of the first feature information acquired in the first acquisition control step to an electronic device, a reception control step of controlling the reception of second feature information indicating a feature of another communication apparatus, and identification information identifying the electronic device, transmitted from the electronic device, a second transmission control step of establishing a connection with the other communication apparatus based on the second feature information received in the reception control step, and controlling the transmission of the first feature information to the other communication apparatus, a formation control step of controlling the storage of the second feature information and controlling the formation of a virtual private network with the other communication apparatus, a request control step of notifying a first information processor, connected to the communication apparatus through a network, of the identification information and controlling the request of the transmission of a predetermined content, and a second acquisition control step of controlling the acquisition of the content transmitted from the first information processor in response to the request in the request control step, wherein the content acquired in the second acquisition control step is shared with the other communication apparatus through the virtual private network formed in the formation control step.

A computer program of the present invention includes a first acquisition control step of controlling the acquisition of stored first feature information indicating a feature of a communication apparatus, a first transmission control step of controlling the transmission of the first feature information acquired in the first acquisition control step to an electronic device, a reception control step of controlling the reception of second feature information indicating a feature of another communication apparatus, and identification information identifying the electronic device, transmitted from the electronic device, a second transmission control step of establishing a connection with the other communication apparatus based on the second feature information received in the reception control step, and controlling the transmission of the first feature information to the other communication apparatus, a formation control step of controlling the storage of the second feature information and controlling the formation of a virtual private network with the other communication apparatus, a request control step of notifying a first information processor, connected to the communication apparatus through a network, of the identification information and controlling the request of the transmission of a predetermined content, and a second acquisition control step of controlling the acquisition of the content transmitted from the first information processor in response to the request in the request control step, wherein the content acquired in the second acquisition control step is shared with the other communication apparatus through the virtual private network formed in the formation control step.

An information processing apparatus of the present invention for managing the issue of an electronic device includes a receiver which receives payment destination information specifying a destination of the payment for a predetermined content acquired by a communication apparatus connected to the information processing apparatus through a network, a management unit which manages the payment destination information received through the receiver and identification information identifying the electronic device by associating the payment destination information with the identification information, and a billing unit which acquires the payment destination information managed by the management unit based on the identification information notified of by the communication apparatus and bills the charge for the content, wherein the identification information is shared in a virtual private network including the communication apparatus and another communication apparatus when the electronic device is placed close to the communication apparatus.

An information processing method of the present invention for managing the issue of an electronic device includes a receiving step of receiving payment destination information specifying a destination of the payment for a predetermined content acquired by a communication apparatus connected to the information processing apparatus through a network, a management step of managing the payment destination information received in the receiving step and identification information identifying the electronic device by associating the payment destination information with the identification information, and a billing step of acquiring the payment destination information managed in the management step based on the identification information notified of by the communication apparatus and billing the charge for the content, wherein the identification information is shared in a virtual private network including the communication apparatus and another communication apparatus when the electronic device is placed close to the communication apparatus.

A storage medium of the present invention, in an information processing apparatus for managing the issue of an electronic device, stores a computer readable program. The computer readable program includes a reception control step of controlling the reception of payment destination information specifying a destination of the payment for a predetermined content acquired by a communication apparatus connected through a network, a management step of managing the payment destination information received in the reception control step and identification information identifying the electronic device by associating the payment destination information with the identification information, and a billing step of acquiring the payment destination information managed in the management step based on the identification information notified of by the communication apparatus and billing the charge for the content, wherein the identification information is shared in a virtual private network including the communication apparatus and another communication apparatus when the electronic device is placed close to the communication apparatus.

A computer program of the present invention for a computer that controls an information processing apparatus for managing the issue of an electronic device includes a reception control step of controlling the reception of payment destination information specifying a destination of the payment for a predetermined content acquired by a communication apparatus connected through a network, a management step of managing the payment destination information received in the reception control step and identification information identifying the electronic device by associating the payment destination information with the identification information, and a billing step of acquiring the payment destination information managed in the management step based on the identification information notified of by the communication apparatus and billing the charge for the content, wherein the identification information is shared in a virtual private network including the communication apparatus and another communication apparatus when the electronic device is placed closed to the communication apparatus.

In accordance with the communication method, the communication apparatus, the storage medium, and the computer program of the present invention, the first feature information indicating the feature of the communication apparatus is stored and then transmitted to the electronic device. The second feature information indicating the feature of the other communication apparatus and the identification information identifying the electronic device are received from the electronic device. Based on the second feature information, the communication apparatus is connected to the other communication apparatus, and the communication apparatus transmits the first feature information to the other communication apparatus. The first feature information is stored in the other communication apparatus. The virtual private network is formed with the other communication apparatus. The communication apparatus transmits the identification information to the first information processor which is connected to the communication apparatus through a network and requests the first information processor to transmit a predetermined content. The content transmitted from the first information processor is acquired. The acquired content is shared with the other communication apparatus through the virtual private network.

In accordance with the information processing method, the information processing apparatus, the storage medium, and the computer program of the present invention, the payment destination information designating the destination of the payment for the predetermined content acquired by the communication apparatus is transmitted from the communication apparatus connected through the network. When the payment destination information is received, the payment destination information and the identification information identifying the electronic device are managed by associating the payment destination information with the identification information. Based on the identification information notified of by the communication apparatus, the managed payment destination information is acquired, and the charge for the content is billed.

### BRIEF DESCRIPTION OF THE DRAWINGS

FIG. 1 shows the configuration of a network system incorporating the present invention;

FIG. 2 is a block diagram showing the construction of an IC (integrated circuit) card of FIG. 1;

FIG. 3 is a block diagram showing the construction of a television receiver of FIG. 1;

FIG. 4 is a block diagram showing the construction of an IC card reader/writer of FIG. 3;

FIG. 5 is a block diagram showing the construction of a hard disk recorder of FIG. 1;

FIG. 6 is a block diagram showing the construction of a PDA (personal digital assistant) of FIG. 1;

FIG. 7 is a flow diagram showing a process of the network system of FIG. 1;

FIG. 8 shows an example of information stored in the IC card;

FIG. 9 is a flow diagram showing another process of the network system shown in FIG. 1;

FIG. 10 shows another example of information stored in the IC card;

FIG. 11 is a flow diagram showing still another process of the network system of FIG. 1;

FIG. 12 shows yet another example of information stored in the IC card;

FIG. 13 is a flow diagram showing a process of the PDA;

FIG. 14 is a flow diagram showing still another process of the network system of FIG. 1;

FIG. 15 is a continuation of the flow diagram of FIG. 14;

FIGS. 16A and 16B show examples of characters;

FIG. 17 shows a network system of the present invention presenting the characters shown in FIGS. 16A and 16B;

FIG. 18 shows another construction of the network system of FIG. 1;

FIG. 19 shows yet another construction of the network system of FIG. 1;

FIG. 20 is a block diagram showing the construction of a content delivery server of FIG. 19;

FIG. 21 is a block diagram showing the construction of a billing device of FIG. 19;

FIG. 22 is a flow diagram showing a process of network system of FIG. 19;

FIG. 23 is a flow diagram showing another process of the network system of FIG. 19; and

FIG. 24 is a flow diagram showing yet another process of the network system of FIG. 19.

### DESCRIPTION OF THE PREFERRED EMBODIMENTS

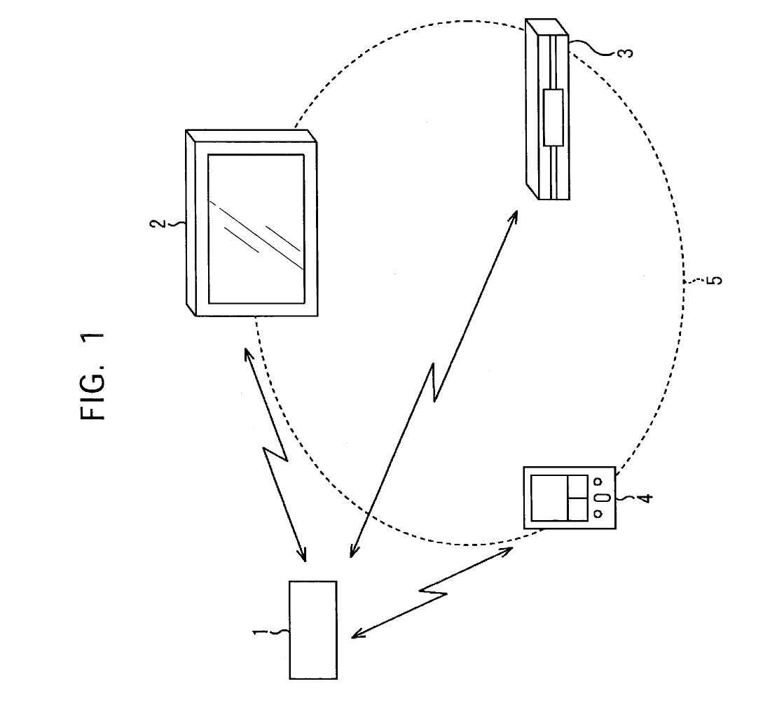

FIG. 1 shows the configuration of a network system incorporating the present invention.

An IC card 1 stores a network ID (identification) as identification information unique to the network system. When the IC card 1 is placed in a predetermined position in the vicinity of each of a television receiver 2, a hard disk recorder 3, and a PDA (Personal Digital Assistant) 4, the network ID is read by each of these apparatuses.

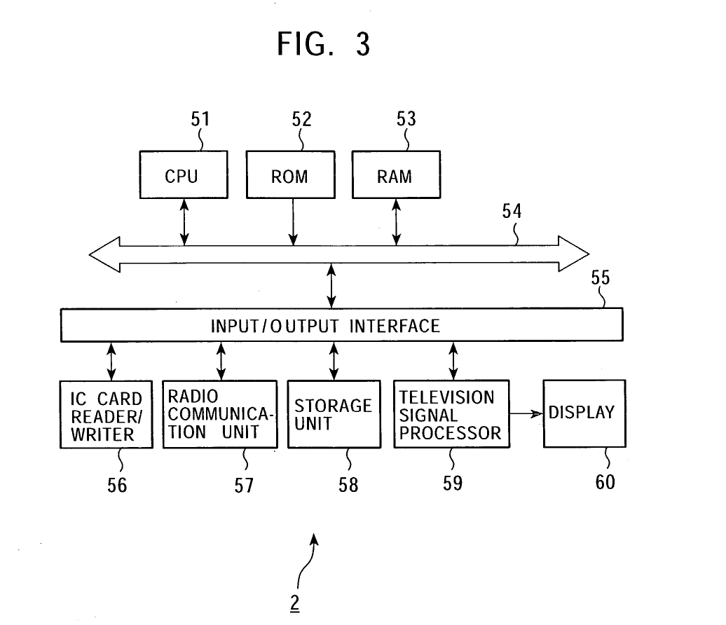

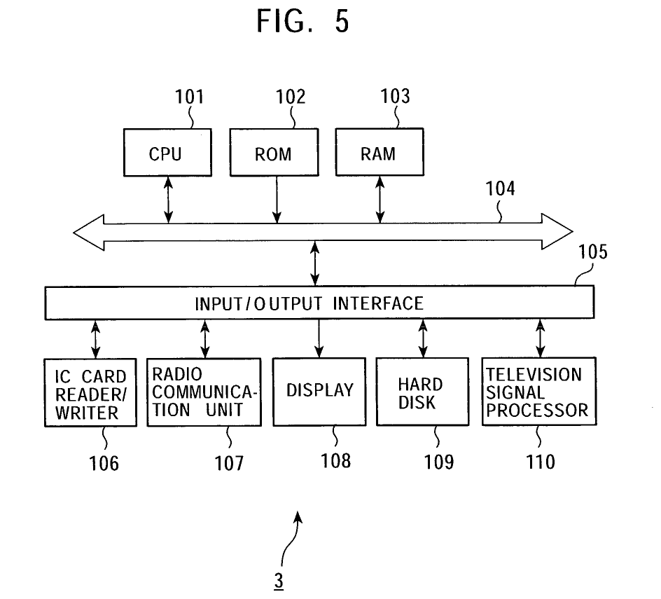

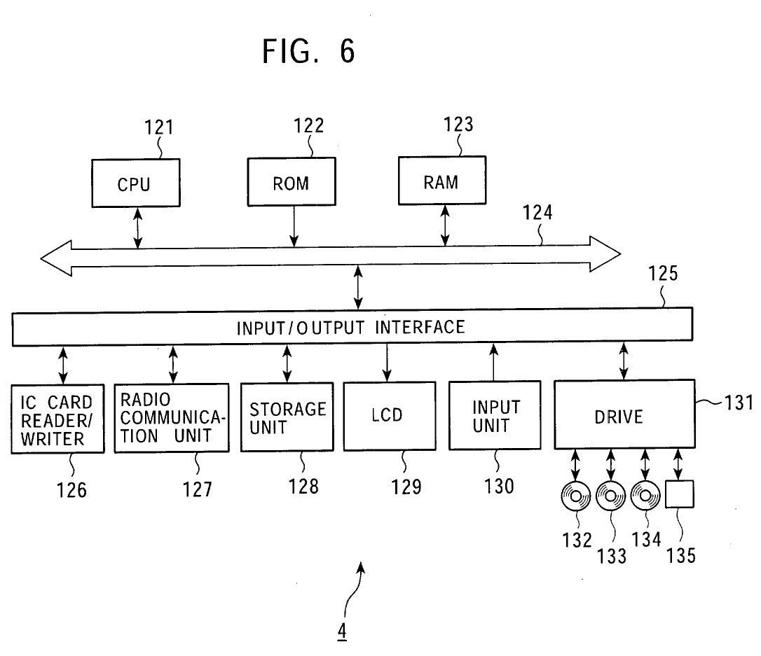

The television receiver 2, the hard disk recorder 3, and the PDA 4 respectively include reader/writers (namely, IC card reader/writers 56 (see FIG. 3), 106 (see FIG. 5), and 126 (see FIG. 6)) which read the network ID stored in the IC card 1 by a non-contact communication.

When the user places the IC card 1 in the vicinity of the IC card reader/writer 106 in the hard disk recorder 3, the hard disk recorder 3 writes, to the IC card 1, a profile (feature information) including the IP address of its own. This process will be discussed in more detail later. Besides the above-mentioned network ID, the IC card 1 stores a list of profiles of closely placed apparatuses such as the television receiver 2 and the hard disk recorder 3. In this embodiment, the IP address is a host part of the IPv6 address.

When the hard disk recorder 3 reads the network ID and the profile list containing the profile (such as the IP address) of the television receiver 2 from the IC card 1, the hard disk recorder 3 accesses the television receiver 2 through a radio communication network such as the one defined in the IEEE (Institute of Electrical and Electronics Engineers) 802.11a, the IEEE802.11b, the IEEE802.11g, or the Bluetooth standard. The hard disk recorder 3 sends, to the television receiver 2, the profile list to which a profile of the hard disk recorder 3 read from the IC card 1 is newly added, and forms a VPN (Virtual Private Network) 5 with the television receiver 2.

When the IC card 1 is placed close to a plurality of apparatuses, a closely placed apparatus is successively added as a member of the VPN 5.

When the VPN 5 is formed between the television receiver 2 and the hard disk recorder 3, the IC card l may be placed close to the reader/writer 126 of the PDA 4. The profile of the PDA 4 is thus added to the profile list stored in the IC card 1.

The PDA 4 reads the profile list which is updated with the profile of its own added, and the network ID from the IC card 1, and accesses the television receiver 2 and the hard disk recorder 3 by the above-mentioned wireless network based on the profiles contained in the read profile list. The PDA 4 notifies the television receiver 2 and the hard disk recorder 3 of the read profile list (the profile list containing the profile of the PDA 4), and shares the same profile list in common, and forms the VPN 5 as illustrated by broken lines in FIG. 1.

The user forms the VPN 5 by simply placing the IC card 1 close to the apparatuses without the need for any complex setting. Rather than the wireless link discussed above, the system forms the VPN 5 using a wired network such as the Ethernet (Registered Trademark).

The apparatuses forming the network system shown in FIG. 1 will be discussed below.

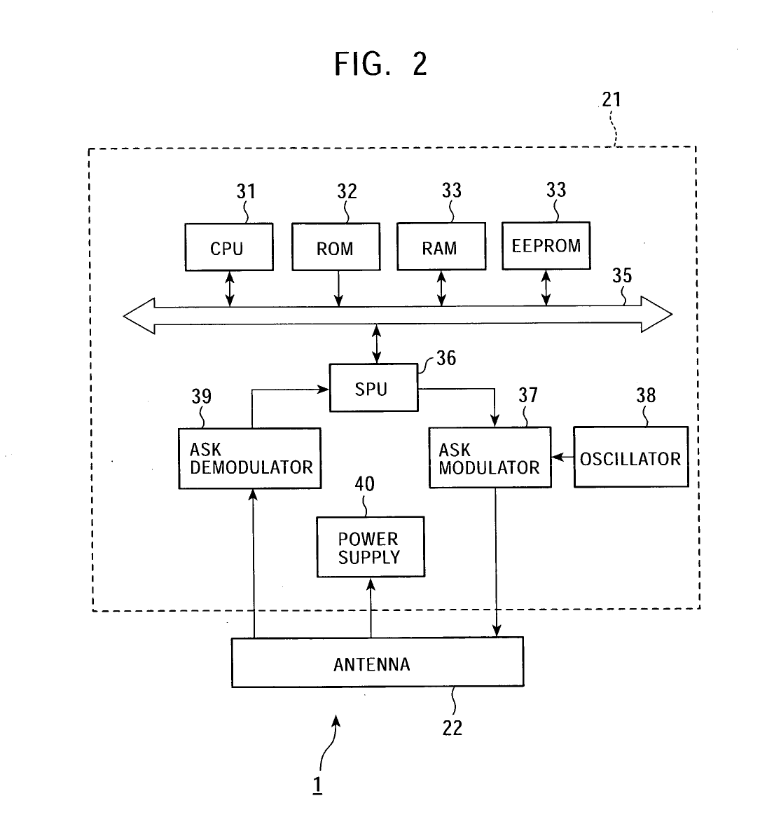

FIG. 2 is a block diagram showing the construction of the IC card 1 of FIG. 1.

The IC card 1 includes an antenna (loop antenna) 22, and an IC 21 which is a single chip IC containing elements other than the antenna 22. Using electromagnetic induction, the IC card 1 exchanges data with the IC card reader/writer 56 in the television receiver 2 in a half-duplex operation.

A CPU (Central Processing Unit) 31 develops a control program stored in an ROM (Read-Only Memory) 32 into an RAM (Random Access Memory) 33, thereby controlling the whole operation of the IC card 1. The CPU 31 notifies the IC card reader/writer 56 in the nearby television receiver 2 of the network ID and the profile list stored in an EEPROM (Electrically Erasable and Programmable Read Only Memory) 34.

An SPU (Signal Processing Unit) 36 decodes data (decodes Manchester codes) in accordance with a clock signal supplied by a PLL (not shown) when data demodulated by a ASK (Amplitude Shift Keying) demodulator 39 is BPSK (Binary Phase Shift Keying) modulated. The demodulated data is output to the CPU 31 through a bus 35 as necessary.

The SPU 36 BPSK modulates data supplied through the bus 35 (encoding into the Manchester codes), and outputs the modulated data to an ASK modulator 37.

When data such as the network ID and the profile list is transmitted to the nearby apparatus, the ASK modulator 37 causes a predetermined switching element to turn on and off in response to the data supplied from the SPU 36. With the switching element turned on, the ASK modulator 37 connects a predetermined load in parallel with the antenna 22, thereby changing the load of the antenna 22.

With the load of the antenna 22 changing, the ASK modulator 37 ASK modulates a modulated wave received through the antenna 22, namely, radiated from the reader/writer of the nearby apparatus. The modulated component is transmitted to the reader/writer of the nearby apparatus through the antenna 22 (changing a terminal voltage across an antenna of the reader/writer) (This operation is referred to as a load switching method).

The ASK demodulator 39 demodulates a modulated signal (an ASK modulated signal) received through the antenna 22 to detect the envelope of the signal, and outputs the demodulated signal to the SPU 36. The antenna 22 resonates in response to an electromagnetic wave at a predetermined frequency radiated from the reader/writer.

A power supply 40 rectifies and regulates an alternating current generated in the antenna 22, and supplies the resulting DC current to each block. For example, the electromagnetic wave radiated from the reader/writer in the television receiver 2 is adjusted in level high enough to operate the IC card 1.

The “IC card” is a terminology used for convenience. The IC card refers to a module having a function described above or to be described later. Felica (Registered Trademark) has substantially the same function as that of the IC card 1.

FIG. 3 is a block diagram showing the construction of the television receiver 2 of FIG. 1.

A CPU 51 carries out a variety of processes in accordance with a computer program stored in an ROM 52 or a storage unit 58. An RAM 53 stores programs carried out by the CPU 51 or data as necessary. The CPU 51, the ROM 52, and the RAM 53 are interconnected to each other through a bus 54.

An input/output interface 55 is connected to the bus 54. Connected to the input/output interface 55 are the IC card reader/writer 56 that communicates with the nearby IC card 1 in a non-contact fashion using an electromagnetic wave, and a radio communication unit 57 that performs radio communication with member apparatuses forming a VPN through a radio communication link as defined in the IEEE (Institute of Electrical and Electronics Engineers) 802.11a, the IEEE802.11b, the IEEE802.11g, or Bluetooth standard.

If the IP address of the hard disk recorder 3 is registered in the profile list read from the IC card reader/writer 56, the radio communication unit 57 accesses the hard disk recorder 3 in accordance with the IP address, and sends a variety of pieces of information such as the network ID and the profile list to the hard disk recorder 3. The radio communication unit 57 also exchanges various pieces of information with a member apparatus forming the VPN.

The storage unit 58 such as the hard disk or flash memory is connected to the input/output interface 55. The storage unit 58 stores the network ID and the profile list read from the IC card 1. Furthermore, the storage unit 58 stores beforehand the profile of the television receiver 2. As will be discussed in detail later, the profile includes information relating to a hardware configuration besides the IP address of the television receiver 2.

A television signal processor 59 includes a front end amplifier, a tuner, a demultiplexer, a decoder, an analog-to-digital converter, etc. The television signal processor 59 processes broadcast radiowaves received by an antenna (not shown), and television program data supplied by the hard disk recorder 3 through communication with the radio communication unit 57, and presents a video on a display 60. A detailed discussion of the construction of the television signal processor 59 is omitted here.

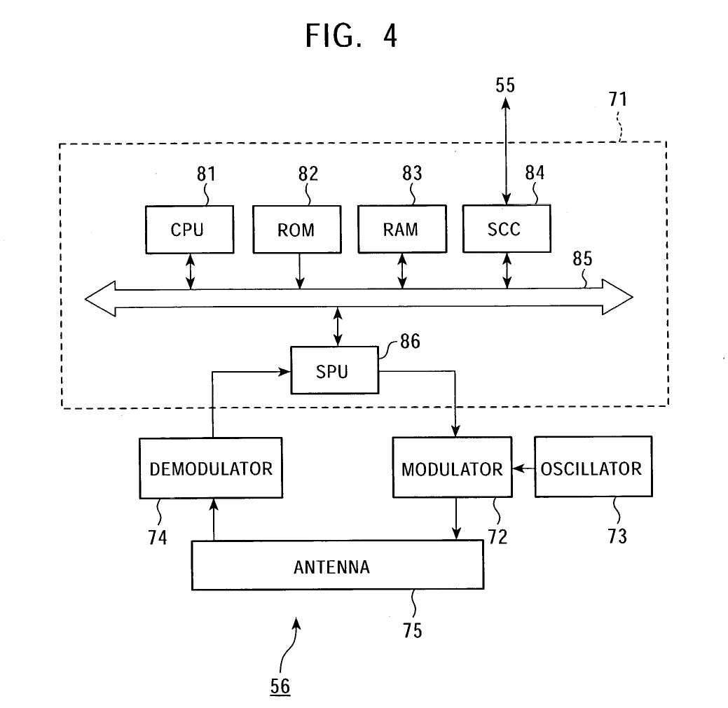

FIG. 4 is a block diagram showing in detail the construction of the IC card reader/writer 56 of FIG. 3.

An IC 71 includes a CPU 81, an ROM 82, an RAM 83, an SCC (Serial Communication Controller) 84, an SPU 86, and a bus 85 which interconnects the components of the CPU 81 through the SPU 86.

The CPU 81 develops a control program stored in the ROM 82 into the RAM 83, and carries out a variety of processes in response to response data transmitted from the IC card 1 and a control signal supplied from the CPU 51 shown in FIG. 3. Furthermore, the CPU 81 generates a command to be transmitted to the IC card 1, and outputs the command to the SPU 86 through the bus 85, and performs an authentication process on data transmitted from the IC card 1.

When the IC card 1 is placed close to the television receiver 2, the television receiver 2 receives the profile list from the IC card 1. In response to a command from the CPU 51, the CPU 81 transfers the profile list to one of the radio communication unit 57 and the storage unit 58.

The SCC 84 supplies the CPU 81 with data from the CPU 51 shown in FIG. 3 through the bus 85, and outputs data provided by the CPU 81 through the bus 85 to the CPU 51.

The SPU 86 BPSK decodes response data received from the IC card 1 through a demodulator 74 (decodes Manchester codes), and supplies the CPU 81 with the resulting data. When a command to be transmitted to the IC card 1 is supplied through the bus 85, the SPU 86 BPSK modulates the command (encodes the command into Manchester codes), and outputs the resulting data to a modulator 72.

The modulator 72 ASK modulates a carrier having a predetermined frequency (at 13.56 MHz, for example) supplied from an oscillator 73 with data supplied from the SPU 86. The modulated signal is then output through an antenna 75 in an electromagnetic wave. The demodulator 74 demodulates a modulated signal (an ASK modulated signal) coming in from the antenna 75, and outputs the demodulated signal to the SPU 86.

The antenna 75 radiates a predetermined electromagnetic wave and the IC card reader/writer 56 determines whether the IC card 1 is within a close range from the antenna 75 based on a change in the load of the antenna 75. If the IC card 1 is within a close range, the antenna 75 exchanges a variety of data with the IC card 1.

The IC card reader/writer 106 in the hard disk recorder 3, and the reader/writer 126 in the PDA 4, both discussed later, have the same construction as that of the IC card reader/writer 56 shown in FIG. 4.

FIG. 5 is a block diagram showing the construction of the hard disk recorder 3 of FIG. 1.

A CPU 101 controls the whole operation of the hard disk recorder 3 through a bus 104 and an input/output interface 105 in accordance with a program stored in an ROM 102 or a hard disk 109.

The IC card reader/writer 106 communicates with the IC card 1 in a non-contact fashion, thereby reading a variety of pieces of information including the network ID and the profile list from the IC card 1.

A radio communication unit 107 communicates with the radio communication unit 57 in the above-referenced television receiver 2 through radio communication based on a radio communication link as defined in the IEEE (Institute of Electrical and Electronics Engineers) 802.11a, the IEEE802.11b, the IEEE802.11g, or Bluetooth standard. Television program data stored in the hard disk 109 is thus sent to the television receiver 2.

A display 108 presents a variety of pieces of information such as current time and pre-programmed record setting on the screen thereof to the user.

The hard disk 109 stores television program data processed and then supplied by a television signal processor 110. For example, data compressed in an MPEG (Moving Picture Experts Group) 2 format is supplied by the television signal processor 110. Furthermore, the hard disk 109 stores the profile of the hard disk recorder 3, and the network ID and the profile list from the IC card 1 read by the IC card reader/writer 106.

The television signal processor 110 compresses a television signal supplied from a tuner (not shown) in the MPEG 2 format, and then feeds the resulting signal to the hard disk 109.

FIG. 6 is a block diagram showing the construction of the PDA 4 of FIG. 1.

A CPU 121 through a radio communication unit 127 are substantially identical to the CPU 101 through the radio communication unit 107 in the hard disk recorder 3 shown in FIG. 5. The reader/writer 126 communicates with the IC card 1 in a non-contact fashion, and the radio communication unit 127 radio-communicates with the apparatuses forming the VPN in compliance with the predetermined standards.

A storage unit 128, for example, formed of a flash memory, stores the profile of the PDA 4 and the network ID and the profile list from the IC card 1 read by the reader/writer 126.

A LCD (Liquid-Crystal Display) 129 presents a variety of pieces of information on the screen thereof to the user in response to a command from the CPU 121. The user, for example, retrieves television program data stored in the hard disk recorder 3, and writes the television program data into the PDA 4 through the VPN 5 to present the corresponding video on the LCD 129.

An input unit 130 includes a touch panel and various input buttons, and conveys inputs from the user to the CPU 121.

A drive 131 is connected to an input/output interface 125. One of a magnetic disk 132, an optical disk 133, a magneto-optical disk 134, a semiconductor memory 135 is loaded in the drive 131 as necessary. A computer program read therefrom is installed in the storage unit 128 as necessary.

The operation of the network system shown in FIG. 1 is discussed below.

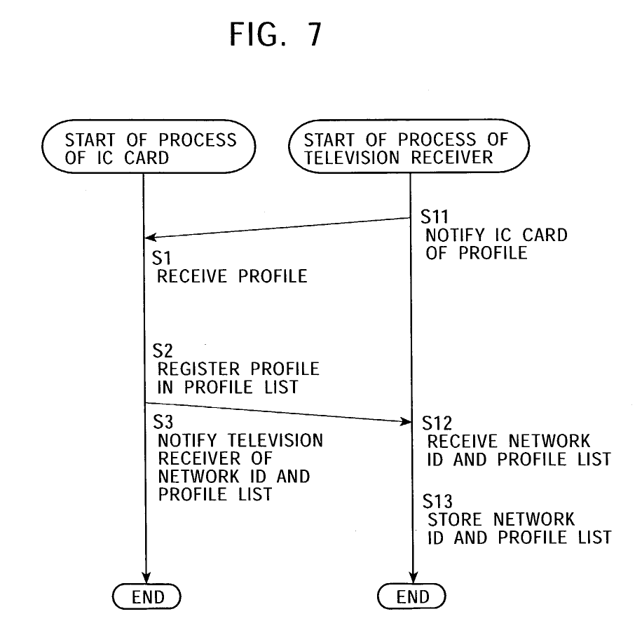

The process carried out by the IC card 1 and the television receiver 2 with no VPN formed yet is discussed with reference to a flow diagram shown in FIG. 7.

The IC card 1 responds to an electromagnetic wave which is periodically output by the IC card reader/writer 56. When the CPU 51 in the television receiver 2 detects a response from the IC card 1 (when the IC card 1 comes within a close range from the television receiver 2), the CPU 51 controls the IC card reader/writer 56 to notify (transmit to) the IC card 1 of the profile of the television receiver 2 stored in the storage unit 58 in step S11.

In step S1, the CPU 31 controls the blocks in the IC card 1 to receive the profile transmitted from the IC card reader/writer 56 in the television receiver 2, and proceeds to step S2. The CPU 31 registers the profile in the profile list stored in the EEPROM 34. In its initial state, the EEPROM 34 has no profile registered.

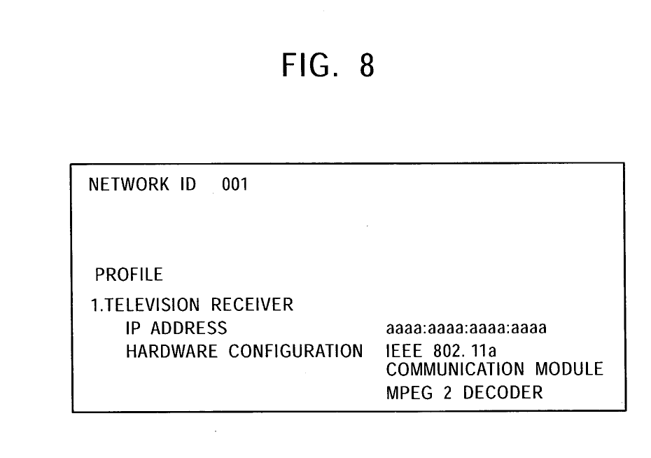

FIG. 8 show an example of information stored in the EEPROM 34 in the IC card 1 registered in step S2.

As shown, the EEPROM 34 stores the network ID set beforehand, and the profile of the television receiver 2 received in step S1. Referring to FIG. 8, the network ID of the IC card 1 is “001”. Registered as the profile of the television receiver 2 are an IP address “aaaa:aaaa:aaaa:aaaa” of the television receiver 2, and “IEEE802.11a COMMUNICATION MODULE” and “MPEG 2 DECODER” as a hardware configuration of the television receiver 2.

In step S3, the CPU 31 sends the information stored in the EEPROM 34, namely, the network ID and the profile list of the television receiver 2 shown in FIG. 8, to the television receiver 2.

In step S12, the CPU 51 in the television receiver 2 receives the network ID and the profile list transmitted from the IC card 1, and then proceeds to step S13 to store the network ID and the profile list in the storage unit 58. In other words, the storage unit 58 in the television receiver 2 stores the same information as that shown in FIG. 8.

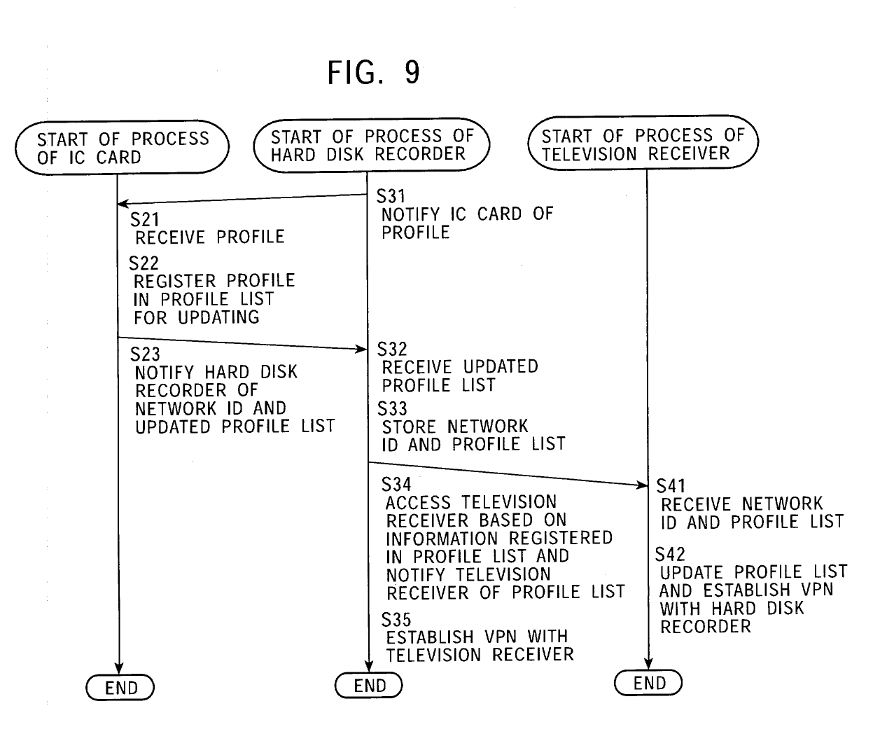

FIG. 9 shows a flow diagram of the process in which the IC card 1 having the profile of the television receiver 2 registered in the process illustrated in FIG. 7 is now placed close to the hard disk recorder 3.

When the IC card reader/writer 106 notifies the CPU 101 in the hard disk recorder 3 that the IC card 1 is detected, the CPU 101 reads the profile of the hard disk recorder 3 stored in the hard disk 109, and sends the profile to the IC card 1 through the IC card reader/writer 106 in step S31.

In step S21, the CPU 31 in the IC card 1 receives the profile from the IC card reader/writer 106 in the hard disk recorder 3, and then proceeds to step S22. The CPU 31 stores, in the EEPROM 34, the profile transmitted from the hard disk recorder 3, thereby updating the information in the profile list.

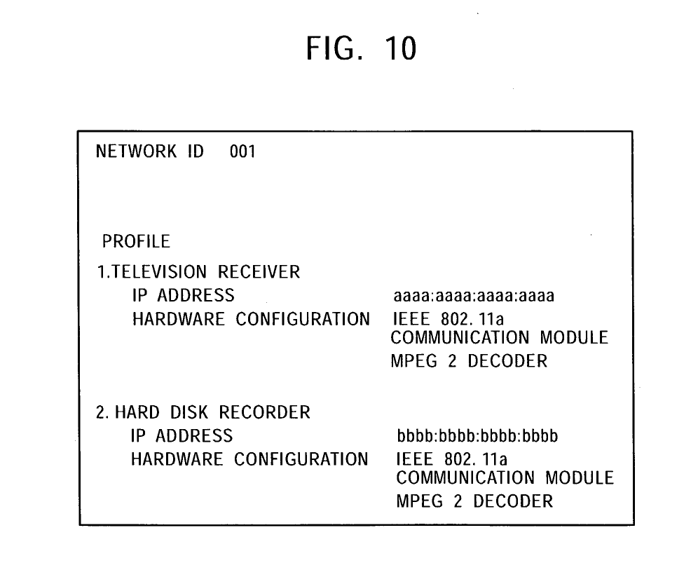

FIG. 10 shows another example of information stored in the EEPROM 34 in step S22.

As shown, the profile list includes the profile of the hard disk recorder 3 received in step S21 besides the information shown in FIG. 8.

In this example, the IP address of the hard disk recorder 3 is “bbbb:bbbb:bbbb:bbbb”, and “IEEE802.11a COMMUNICATION MODULE” and “MPEG2 DECODER” are added in the hard disk recorder 3.

In step S23, the CPU 31 in the IC card 1 controls the IC card reader/writer 56 to notify the hard disk recorder 3 of the network ID and the profile list stored in the EEPROM 34.

The CPU 101 in the hard disk recorder 3 receives information from the IC card 1 in step S32, and stores the information in the hard disk 109 in step S33.

In step S34, the CPU 101 controls the radio communication unit 107 to access the television receiver 2 in accordance with the information registered in the profile list. The CPU 101 notifies the television receiver 2 of the updated profile list including the profile of its own (namely, of the hard disk recorder 3).

If the information illustrated in FIG. 10 is stored in the hard disk 109 subsequent to the process in step S33, the CPU 101 controls the radio communication unit 107, which is an IEEE802.11a communication module, and accesses the television receiver 2 in accordance with the IP address of “aaaa:aaaa:aaaa:aaaa”, and transmits the information of the entire profile list to the television receiver 2 through radio communication in compliance with the IEEE802.11a standard.

In this way, the profile of the hard disk recorder 3 is acquired by the television receiver 2 (in other words, the profile list registered in the IC card 1 is commonly shared).

In step S35, the CPU 101 performs a variety of settings, and forms a VPN with the television receiver 2.

In step S41, the CPU 51 in the television receiver 2 controls the radio communication unit 57, thereby receiving the information transmitted from the hard disk recorder 3. In step S42, the CPU 51 updates the profile list stored in the storage unit 58 with the received information, and forms a VPN with the hard disk recorder 3. In other words, the information shown in FIG. 10 is stored in the storage unit 58, and the VPN is set up with the hard disk recorder 3 after the predetermined setting is performed.

The user in this way transfers the television program data stored in the hard disk recorder 3 to the television receiver 2 via the VPN 5 to present the corresponding video on the screen of the television receiver 2. In the hard disk recorder 3, the stored program data is read from the hard disk 109, and is then transmitted from the radio communication unit 107 to the television receiver 2 through radio communication in compliance with the IEEE802.11a standard. The transmitted program data is received by the radio communication unit 57 in the television receiver 2, and is then processed by the television signal processor 59 for replaying. The video of the program is thus presented on the display 60.

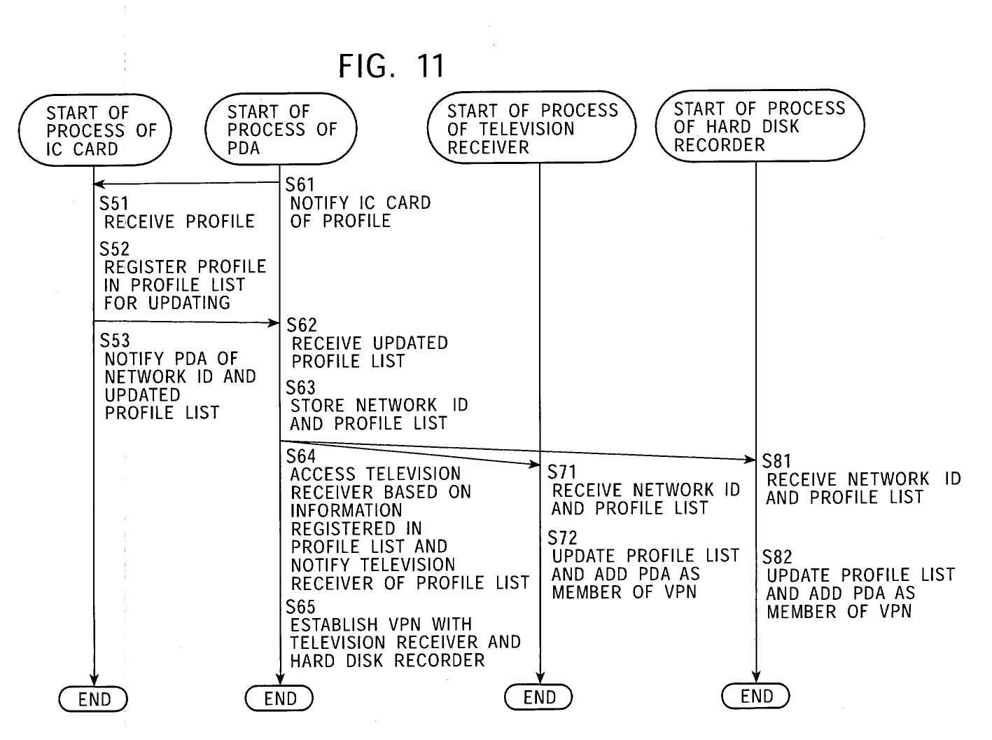

A flow diagram in FIG. 11 shows the process performed when the IC card 1 comes within a close range of the PDA 4 after the VPN is established between the television receiver 2 and the hard disk recorder 3. The PDA 4 also performs a process similar to that performed by the hard disk recorder 3 as discussed with reference to FIG. 9.

When the reader/writer 126 notifies the CPU 121 in the PDA 4 that the IC card 1 is detected, the CPU 121 reads the profile of its own stored in the storage unit 128 and notifies the IC card 1 of the profile through the reader/writer 126 in step S61.

In step S51, the CPU 31 in the IC card 1 receives the profile transmitted from the reader/writer 126 in the PDA 4, and then proceeds to step S52 to store the profile in the EEPROM 34. The CPU 31 thus updates the profile list.

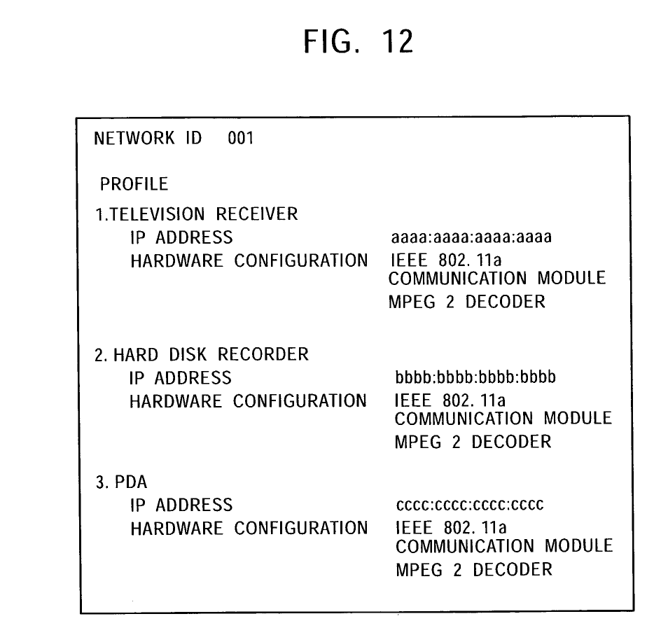

FIG. 12 shows yet another example of information stored in the EEPROM 34 in step S52.

As shown, the profile list includes the profile of the PDA 4 received in step S51 in addition to the information illustrated in FIG. 10.

The IP address of the PDA 4 is “cccc:cccc:cccc:cccc” and an “IEEE802.11a COMMUNICATION MODULE” and an “MPEG2 DECODER” are set in the PDA 4.

In step S53, the CPU 31 in the IC card 1 controls the IC card reader/writer 56, thereby notifying the PDA 4 of the network ID and the updated profile list stored in the EEPROM 34.

The CPU 121 in the PDA 4 receives the information notified of by the IC card 1 in step S62, and stores the information in the storage unit 128 in step S63.

In step S64, the CPU 121 controls the radio communication unit 127, thereby accessing the television receiver 2 and the hard disk recorder 3 in accordance with the information registered in the profile list. The CPU 121 then notifies the television receiver 2 and the hard disk recorder 3 of the profile list that includes the profile of its own (of the PDA 4).

If the information shown in FIG. 12 is stored in the storage unit 128 subsequent to step S63, the CPU 121 controls the radio communication unit 127, which is an IEEE802.11a communication module, and accesses the television receiver 2 in accordance with the IP address “aaaa:aaaa:aaaa:aaaa”, and transmits the profile list to the television receiver 2. In accordance with the IP address “bbbb:bbbb:bbbb:bbbb”, the CPU 121 accesses the hard disk recorder 3, thereby notifying the hard disk recorder 3 of the profile list.

In this way, the profile of the PDA 4 is acquired by the television receiver 2 and the hard disk recorder 3. The profiles of the apparatuses and the network ID of the IC card 1 are commonly shared among these apparatuses.

In step S65, the CPU 121 performs a predetermined setting, thereby forming a VPN with the television receiver 2 and the hard disk recorder 3.

In step S71, the CPU 51 in the television receiver 2 controls the radio communication unit 57, thereby receiving the information sent from the PDA 4. The CPU 51 proceeds to step S72 to update the profile list stored in the storage unit 58 in accordance with the received information. The PDA 4 is added as a member apparatus forming the VPN. In other words, the information shown in FIG. 12 is stored in the storage unit 58.

In step S81, the CPU 101 in the hard disk recorder 3 controls the radio communication unit 107, thereby receiving the information transmitted from the PDA 4. The CPU 101 proceeds to step S82 to update the profile list stored in the hard disk 109 in accordance with the received information. The PDA 4 is added as a member apparatus forming the VPN. In other words, the information shown in FIG. 12 is stored in the hard disk 109. The VPN 5, formed of the television receiver 2, the hard disk recorder 3, and the PDA 4, results as shown in FIG. 1.

The user easily and quickly establishes the VPN 5 formed of these apparatuses by simply placing the IC card 1 close to each apparatus. To add a new apparatus as a member apparatus of the VPN, the user simply places the IC card 1 close to a reader/writer of the new apparatus.

In the above discussion, all apparatuses to which the IC card 1 is placed close are added as member apparatuses of the VPN. A secure VPN may be established by performing an authentication process between these apparatuses. In this case, the user must set up a password for each member apparatus.

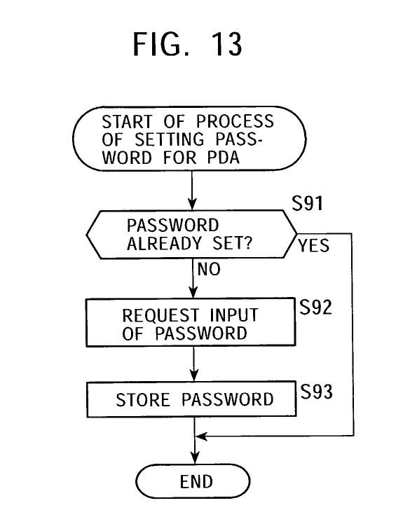

The process of the PDA 4 for setting a password is discussed with reference to a flow diagram shown in FIG. 13. The same process is performed on each of the television receiver 2 and the hard disk recorder 3.

In step S91, the CPU 121 in the PDA 4 determines whether a password is set. If it is determined that a password is set, the process ends. If it is determined in step S91 that no password is set, the algorithm proceeds to step S92. The CPU 121 requests the user to input the password. For example, the CPU 121 presents a predetermined input screen on the LCD 129 to request the user to input the password there.

When the user operates the input unit 130 to input a password of a predetermined number of alphanumeric characters, the CPU 121 stores the password in the storage unit 128 in step S93.

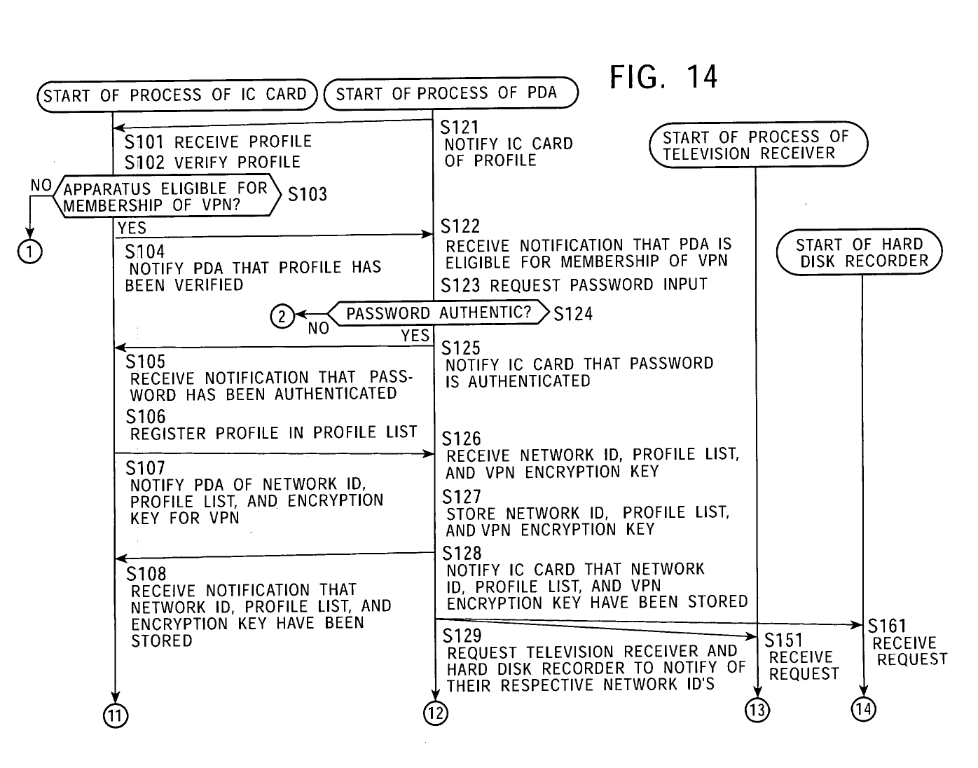

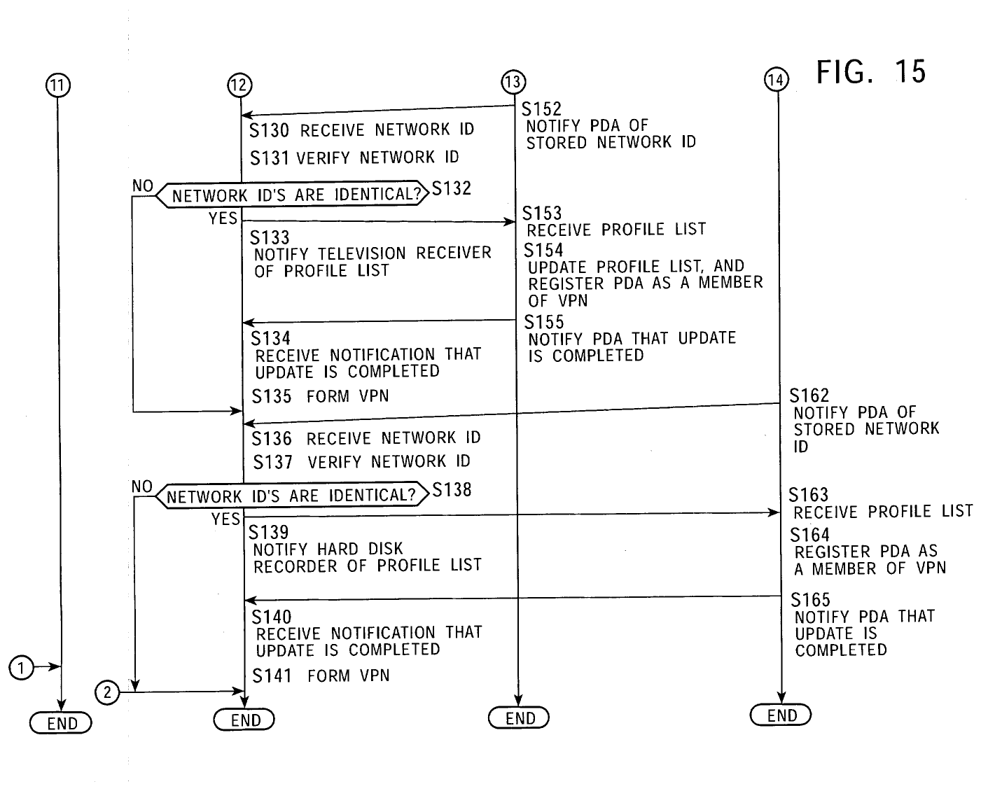

The process of adding the PDA 4 having the password set therewithin to the VPN is discussed with reference to flow diagrams shown in FIGS. 14 and 15. The process is substantially identical to the process already discussed with reference to FIG. 11. The same authentication process is performed when each of the television receiver 2 and the hard disk recorder 3 is added to the VPN.

When the reader/writer 126 notifies the CPU 121 in the PDA 4 that the IC card 1 is detected, the CPU 121 informs the IC card 1 of the profile of its own in step S121.

In step S101, the CPU 31 in the IC card 1 receives the profile from the PDA 4, and proceeds to step S102 to verify the content of the profile.

In step S103, the CPU 31 in the IC card 1 determines whether the PDA 4 is eligible for registration as a member apparatus of the VPN (formed of the television receiver 2 and the hard disk recorder 3). If it is determined that the PDA 4 is not eligible, the algorithm ends.

The user operates one of the television receiver 2 and the hard disk recorder 3, which are already registered in the VPN, to set, in the IC card 1, the IP address of an apparatus, or the hardware configuration criterion of an apparatus to inhibit the registration of that apparatus as a member for the VPN.

If “MPEG 2 DECODER” is set as a hardware configuration criterion required of an apparatus to be eligible for the VPN, the user inhibits an apparatus having no “MPEG 2 DECODER” from being added as a member apparatus for the VPN. This arrangement prevents an apparatus unable to replay a content compressed in the MPEG 2 format from being registered into the VPN if the VPN shares the content complying with the MPEG 2.

If the CPU 31 determines in step S103 that the PDA 4 is eligible as a member apparatus for the VPN, the algorithm proceeds to step S104. The CPU 31 notifies the PDA 4 that the profile has been verified (that the PDA 4 is eligible as a member apparatus for the VPN).

This notification is received by the reader/writer 126 in the PDA 4 in step S122. The CPU 121 requests the user to input the password in step S123. In step S124, the CPU 121 determines whether the input password is identical to that input in the process shown in FIG. 13, in other words, determines whether the input password is authentic.

If the CPU 121 determines in step S123 that the input password is unauthentic, the CPU 121 ends the process, else the CPU 121 proceeds to step S125. The CPU 121 notifies the IC card 1 that the input password is verified.

By authenticating a password, an apparatus which the IC card 1 approaches by chance is prevented from being automatically registered as a member apparatus for the VPN.

The notification that the password has been authenticated is received by the IC card 1 in step S105. In step S106, the CPU 31 in the IC card 1 registers the profile of the PDA 4 in the profile list.

In step S107, the CPU 31 in the IC card 1 notifies the PDA 4 of the network ID, the profile list, and a VPN encryption key stored in the EEPROM 34. When a content is shared in a formed VPN, the VPN encryption key is used to authenticate an apparatus, or to encrypt the content.

These pieces of information coming in from the IC card 1 are received by the reader/writer 126 in the PDA 4 in step S126, and are then stored in the storage unit 128 in step S127.

In step S128, the CPU 121 in the PDA 4 notifies the IC card 1 that the network ID, the profile list, and the VPN encryption key have been stored. This notification is received by the IC card 1 in step S108.

In step S129, the CPU 121 in the PDA 4 accesses the television receiver 2 and the hard disk recorder 3 in accordance with the information registered in the profile list, and requests each apparatus to send the respective stored network ID.

This request is received by the radio communication unit 57 in the television receiver 2 in step S151. In step S152, the CPU 51 in the television receiver 2 controls the radio communication unit 57, thereby transmitting the network ID stored in the storage unit 58 to the PDA 4.

The network ID transmitted from the television receiver 2 is received by the radio communication unit 127 in the PDA 4 in step S130. The CPU 121 in the PDA 4 authenticates the network ID. In step S131, the CPU 121 in the PDA 4 checks the network ID notified of by the television receiver 2 and the network ID stored in the storage unit 128, and determines in step S132 whether the two network ID's are identical.

If the CPU 121 determines in step S132 that the notified network ID is identical to the network ID of its own, the algorithm proceeds to step S133. The CPU 121 sends an updated profile list notified of by the IC card 1 to the television receiver 2 through the radio communication unit 127.

One apparatus, which was registered as a member of the VPN by the IC card 1 (when the IC card 1 has been placed close to that apparatus), is currently registered as a member of another VPN by another IC card. Such an apparatus is prevented from being registered again as a new member of the VPN by the IC card 1 by checking the network ID.

In step S153, the profile list transmitted from the PDA 4 is received by the radio communication unit 57 in the television receiver 2, and is stored in the storage unit 58. The profile list there is updated. The PDA 4 is thus added as a member of the VPN.

In step S155, the CPU 51 in the television receiver 2 notifies the PDA 4 that the updating of the profile list is completed. The algorithm ends.

In step S134, the CPU 121 in the PDA 4 receives the notification from the television receiver 2. In step S135, the CPU 121 in the PDA 4 performs a variety of settings, thereby forming a VPN with the television receiver 2. If it is determined in step S132 that the network ID transmitted from the television receiver 2 is not identical to the network ID stored in the storage unit 128, step S133 through step S135 are skipped.

In response to the request of the PDA 4 to notify the PDA 4 of the network ID, the CPU 101 in the hard disk recorder 3 performs the same process as that of the CPU 51 in the television receiver 2 in step S162 through step S165.

In step S162, the CPU 101 in the hard disk recorder 3 controls the radio communication unit 107, thereby notifying the PDA 4 of the network ID stored in the hard disk 109.

In step S136, the network ID transmitted from the hard disk recorder 3 is received by the radio communication unit 127 in the PDA 4. In step S137, the network ID is verified. In step S138, the CPU 121 in the PDA 4 determines whether the network ID transmitted from the hard disk recorder 3 is identical to the network ID stored in the storage unit 128. If it is determined that the two network ID's are not identical, the algorithm ends.

If the CPU 121 determines in step S138 that the network ID transmitted from the hard disk recorder 3 is identical to the network ID stored in the storage unit 128, the algorithm proceeds to step S139. The CPU 121 then notifies the hard disk recorder 3 of the profile list transmitted from the IC card 1.

In step S163, the profile list transmitted from the PDA 4 is received by the radio communication unit 107 in the hard disk recorder 3, and is used to update the profile list stored in the hard disk 109. In step S164, the PDA 4 is added as a member forming the VPN.

In step S165, the CPU 101 in the hard disk recorder 3 notifies the PDA 4 that the updating of the profile list has been completed, and ends the process.

The CPU 121 in the PDA 4 receives the notification from the hard disk recorder 3 in step S140. In step S141, the CPU 121 performs a predetermined setting, thereby forming a VPN with the hard disk recorder 3.

By verifying the password uniquely set to each apparatus and the network ID stored in each apparatus, the user reliably forms the VPN desired by the user himself or herself. When the apparatuses communicate with each other, the network ID's thereof are mutually authenticated. A secure VPN thus results.

The user can easily and quickly form the VPN by simply placing the IC card 1 close to each apparatus. Since the above-referenced processes are carried out in response to an action such as simply placing the IC card 1 to each apparatus, the VPN is intuitively formed.

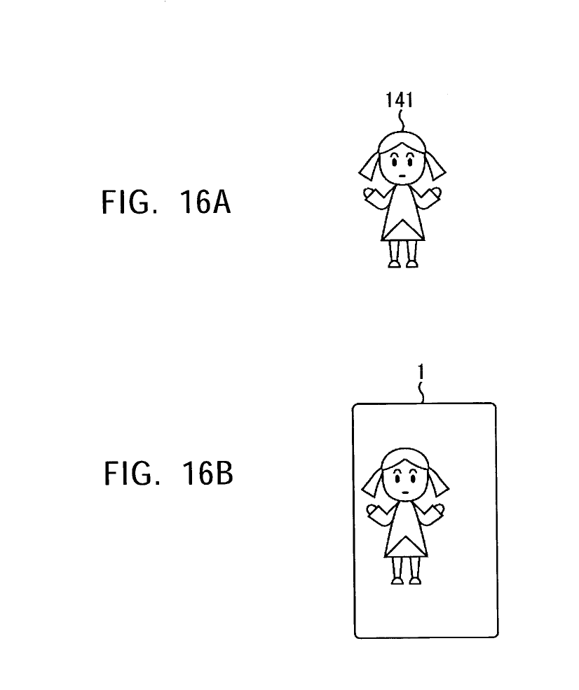

A character 141 shown in FIG. 16A is presented on the display of each apparatus forming the same VPN. The user thus easily recognizes the apparatus forming the VPN by an on-screen image.

Referring to FIG. 16B, the character 141 is printed on the surface of the IC card 1, and image data of the character 141 is stored beforehand in the EEPROM 34 of the IC card 1.

When the IC card 1 is placed close to each apparatus, prepared image data, further to the network ID and the profile list, is fed to the nearby apparatus. These pieces of information are shared in common by the television receiver 2, the hard disk recorder 3, and the PDA 4.

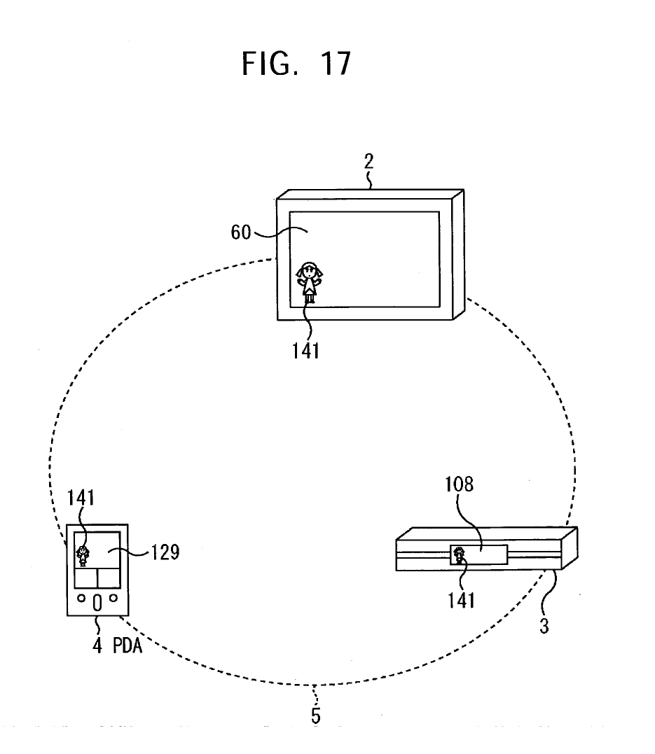

The image of the character 141 responsive to the image data is presented on the display of each apparatus. FIG. 17 shows a VPN including the apparatuses that present the character 141.

Referring to FIG. 17, the image of the character 141 stored in the IC card 1 is presented on the display of each of the display 60 in the television receiver 2, the display 108 in the hard disk recorder 3, and the LCD 129 in the PDA 4.

Even when a plurality of VPN's are located in a single room, the user easily recognizes which VPN is formed of what apparatus by checking the display of each apparatus.

When an expiration date is set in the network ID, the remaining period of the network ID to the expiration date is represented by the character 141. For example, a plurality of characters 141 having different moods are prepared for the network ID. When a substantial period of time remains before the expiration date, the image of a cheerful character 141 is presented. When a little period of time remains, the image of a cheerless character 141 is presented. In this way, the user easily knows the expiration date of the network ID.

Not only the character 141 but also mere alphanumeric letters may be presented on each apparatus to indicate the VPN to which the apparatus belongs to.

The apparatuses forming the VPN 5 are the television receiver 2, the hard disk recorder 3, and the PDA 4 in the above discussion. Furthermore, a diversity of apparatuses such as a personal computer, a mobile telephone, and a game playing machine may be included in the VPN.

If the apparatuses are linked to the Internet, a management server for managing the IP address and the hardware configuration of each apparatus, and the network ID stored in the IC card 1 may be arranged. The VPN is thus managed by the management server.

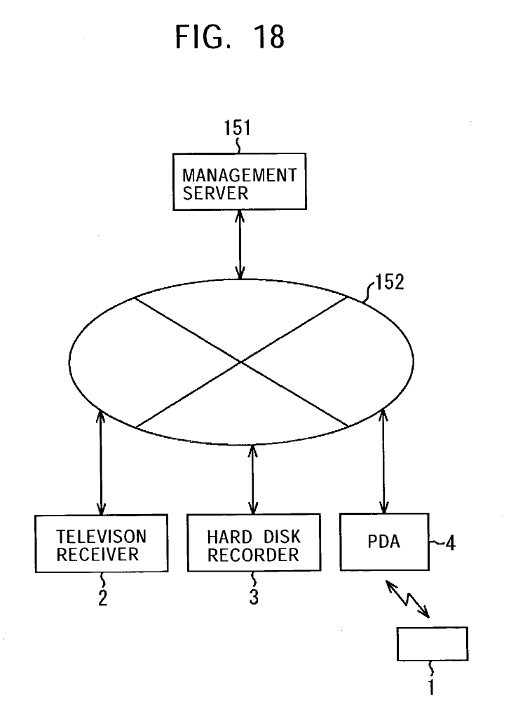

FIG. 18 shows the concept of a network system in which the VPN is managed by a management server 151.

The management server 151 manages the IP addresses of the television receiver 2, the hard disk recorder 3, and the PDA 4 sent through a network 152. When the network ID of the IC card 1 is notified of by each apparatus, the management server 151 manages the information of the IP addresses and the network ID by associating the IP addresses with the network ID.

As shown, when the IC card 1 is placed close to the PDA 4, the PDA 4 reads the network ID of the IC card 1. The read network ID is sent together with the IP address of the PDA 4 to the management server 151 through the network 152.

The management server 151 searches for management information when the network ID comes in from the PDA 4. The management server 151 determines whether there is present an apparatus that has already notified of a network ID identical to that notified of by the PDA 4. For example, the IC card 1 has been placed close to the television receiver 2 before the IC card 1 is placed close to the PDA 4, and the network ID of the IC card 1 has already been informed by the television receiver 2. The management server 151 then notifies the PDA 4 of the IP address of the television receiver 2 while notifying the television receiver 2 of the IP address of the PDA 4 at the same time.

The PDA 4 accesses the television receiver 2 in accordance with the IP address transmitted from the management server 151, and forms a VPN with the television receiver 2.

With the management server 151 managing the apparatuses forming the VPN, the user easily forms a VPN by simply placing the IC card 1 close to each of the apparatus in the same way as already described.

In the above discussion, the IC card 1 is used to form a VPN. In the VPN thus constructed, a variety of pieces of information are shared in common among the apparatuses forming the VPN.

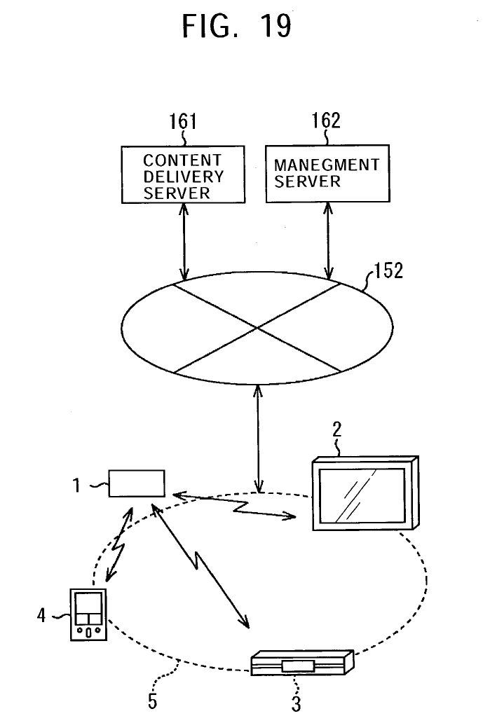

FIG. 19 shows the concept of a network system which shares in common a content downloaded from a predetermined server.

Referring to FIG. 19, the VPN 5 is formed of the television receiver 2, the hard disk recorder 3, and the PDA 4 by placing the IC card 1 in the vicinity of each of these apparatuses. The VPN 5 is connected to the network 152 such as the Internet. A content delivery server 161 and a billing device 162 are connected to the network 152.

In response to a request from one of the television receiver 2, the hard disk recorder 3, and the PDA 4, the content delivery server 161 transmits a variety of contents such as a movie content, a music content, and applications through the network 152. The content delivery server 161 requests each apparatus to purchase a content, while notifying the billing device 162 of the network ID transmitted from, for example, the television receiver 2, for example, and requesting the billing device 162 to perform a billing process for the content.

The billing device 162 manages the issuing of the IC card, and further manages the network ID of the IC card and the information of a the credit card number and a bank account number of the holder of the IC card by associating these pieces of information with the network ID. In response to the notification of the price of the content and the network ID by the content delivery server 161, the billing device 162 references the registered information and collects money for the content.

Since the billing process is performed based on the network ID shared within the VPN 5, the user can download a content from the content delivery server 161 to any of the television receiver 2, the hard disk recorder 3, and the PDA 4 once the user registers the information such as the credit card number.

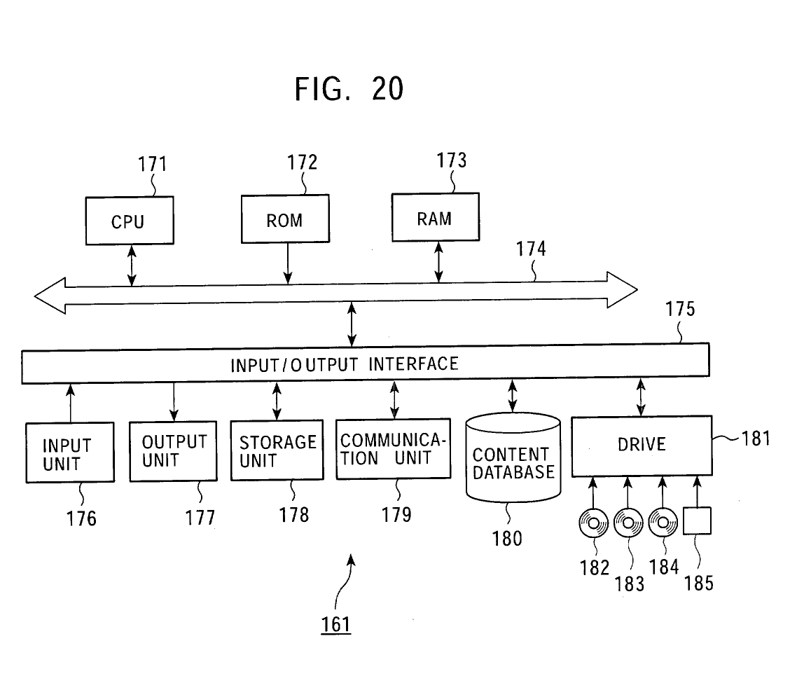

FIG. 20 is a block diagram showing the construction of the content delivery server 161.

A CPU 171 carries out a variety of processes in accordance with a computer program stored in an ROM 172, or a computer program loaded from a storage unit 178 to an RAM 173. The RAM 173 also stores data required by the CPU 171 when the CPU 171 carries out the processes.

The CPU 171, the ROM 172, and the RAM 173 are interconnected to each other through a bus 174. The bus 174 is connected to an input/output interface 175.

Also connected to the input/output interface 175 are an input unit 176 such as a keyboard or a mouse, an output unit 177 such as a display including a CRT (Cathode Ray Tube) or an LCD, or a loudspeaker, a storage unit 178 such as a hard disk, and a communication unit 179 such as a modem, or a terminal adaptor.

The communication unit 179 performs a communication process through the communication unit 179, for example, sends a content read from a content database 180.

The content database 180 stores a diversity of contents such as movie contents, music contents, and applications. In response to a command from the CPU 171, the content database 180 reads a desired content, and transfers it to the communication unit 179 as necessary.

A drive 181 is connected to the input/output interface 175 as necessary, and one of a magnetic disk 182, an optical disk 183, a magneto-optical disk 184, and a semiconductor memory 185 is loaded to the drive 181. A computer program read therefrom is installed in the storage unit 178.

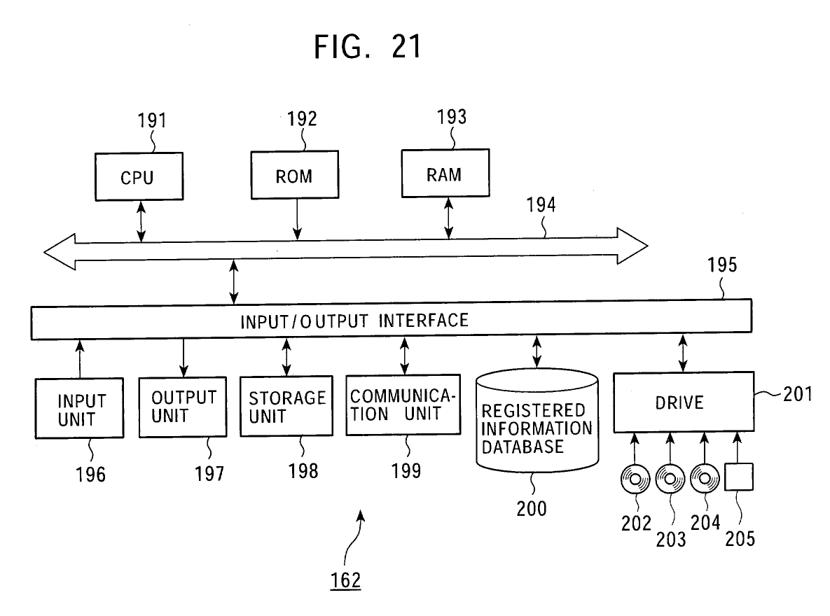

FIG. 21 is a block diagram showing the construction of the billing device 162. The billing device 162 has a construction substantially identical to that of the content delivery server 161 illustrated in FIG. 20. Like elements are identified with like reference numerals, and the detailed discussion thereof is omitted here.

A communication unit 199 communicates with the content delivery server 161 and the apparatuses of the VPN, and receives a credit card number transmitted from, for example, the television receiver 2, and stores the credit card number in a registered information database 200.

The registered information database 200 manages the network ID of the issued IC card, and user information such as the name and address of the holder of the IC card, a credit card number, and a balance in a bank account of the holder by associating the network ID with the user information.

The operation of the network system shown in FIG. 19 is discussed below.

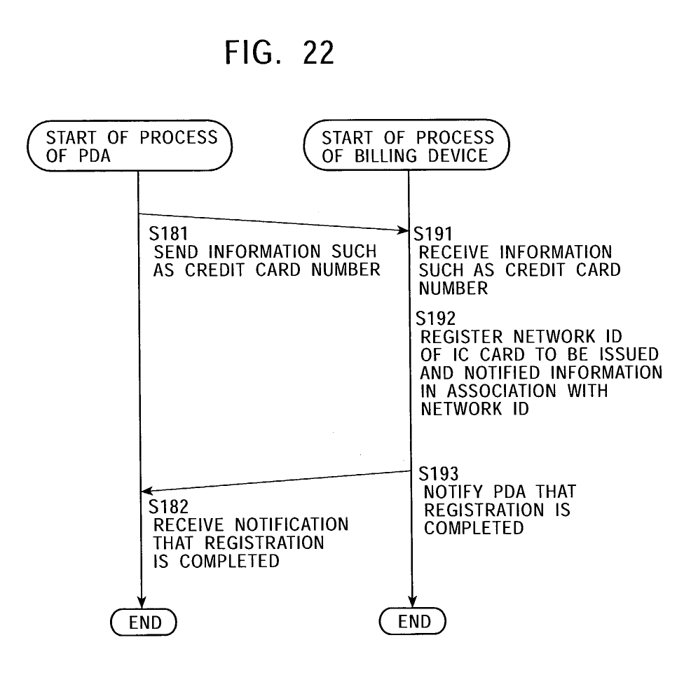

A process of registering a variety of pieces of information such as a credit card number performed between the PDA 4 and the billing device 162 is discussed with reference to a flow diagram shown in FIG. 22.

This process is carried out prior to the issue of the IC card. To use the above-referenced IC card, the user must register the information such as the credit card number in the billing device 162.

The user operates the input unit 130 to instruct the CPU 121 in the PDA 4 to gain access to the billing device 162. The CPU 121 accesses the billing device 162 and notifies the billing device 162 of the information input by the user, such as the name and address of the user, and the credit card number. Specifically, the CPU 121 controls the radio communication unit 127 to access the billing device 162, and presents a predetermined registration screen on the LCD 129. When the user inputs these pieces of information monitoring the registration screen, the CPU 121 transmits the information to the billing device 162 through the radio communication unit 127.

A CPU 191 in the billing device 162 receives the information transmitted from the PDA 4 in step S191. In step S192, the CPU 191 stores, in the registered information database 200, the received information and the network ID of the IC card to be issued with the information respectively associated with the IC card.

In step S193, the CPU 191 notifies the PDA 4 that the registration is completed, and ends the process. In step S182, the notification that the registration is completed is received.

An IC card is then issued to a user who has registered these pieces of information.

The user who gets the IC card 1 forms the VPN 5 through the process discussed with reference to the flow diagrams shown in FIGS. 14 and 15. The user purchases a content by accessing the content delivery server 161 through an apparatus forming the VPN 5.

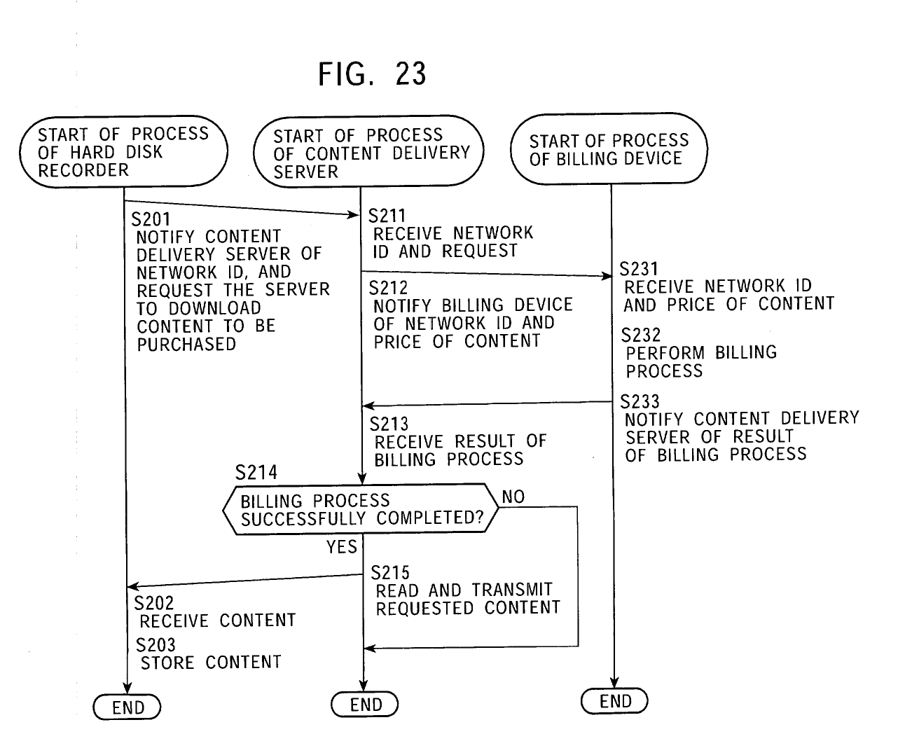

A series of processes for downloading a content carried out between the hard disk recorder 3, the content delivery server 161, and the billing device 162 is discussed with reference to a flow diagram shown in FIG. 23.

In step S201, the CPU 101 in the hard disk recorder 3 controls the radio communication unit 127, thereby accessing the content delivery server 161. The CPU 101 then notifies the content delivery server 161 of the network ID stored in the hard disk 109 (the network ID of the IC card 1) and information identifying the content, the purchase of which is requested by the user.

In step S211, the content delivery server 161 receives the network ID and the content identification information transmitted from the hard disk recorder 3.

The CPU 171 in the content delivery server 161 references information stored in the content database 180 to calculate the price of the content to be downloaded. The CPU 171 notifies the billing device 162 of the calculated price and the network ID in step S212.

In step S231, the CPU 191 in the billing device 162 receives the network ID and the price information transmitted from the content delivery server 161. In step S232, the CPU 191 pays the bill. Specifically, based on the informed network ID, the CPU 191 reads information such as a credit card number from the registered information database 200, and debits the amount for the content to the account designated by that number.

The CPU 191 notifies the content delivery server 161 of the result of the debit (of whether the amount is successfully collected) in step S233.

In step S213, the CPU 171 in the content delivery server 161 receives the notification from the billing device 162. In step S214, CPU 171 determines whether the billing process has been successfully completed based on the notification from the billing device 162.

If the CPU 171 determines in step S214 that the billing process has not successfully been completed (if the CPU 171 is notified that the amount is not successfully debited), the CPU 171 ends the process, else the algorithm proceeds to step S215.

In step S215, the CPU 171 reads the content requested by the hard disk recorder 3 from the content database 180, and transmits the content through the communication unit 179. The content to be transmitted here may be encrypted using the network ID and the VPN encryption key.

The CPU 101 in the hard disk recorder 3 receives the content transmitted from the content delivery server 161 in step S202, and then stores the content in the hard disk 109 in step S203. The content to be stored here may be encrypted using the network ID and the VPN encryption key.

Since the same network ID is shared in common over the same VPN, the user can purchase a content from any apparatus forming the VPN. The payment is centrally managed by the billing device 162.

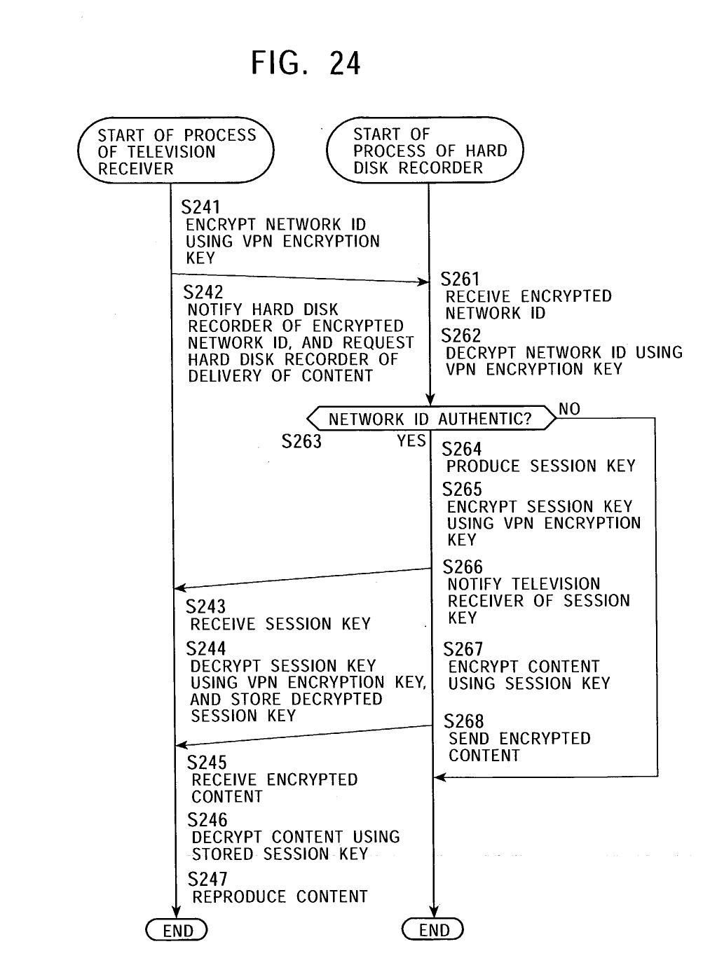

A process of replaying a content downloaded from the content delivery server 161 on the television receiver 2 which shares the same VPN with the hard disk recorder 3 is discussed below with reference to FIG. 24. As already described, information is shared in common among the apparatuses forming the VPN.

In step S241, the CPU 51 in the television receiver 2 encrypts the network ID using the VPN encryption key stored in the storage unit 58. Subsequent to the process discussed with reference to FIGS. 14 and 15, the television receiver 2, the hard disk recorder 3, and the PDA 4 forming the VPN share in common the VPN encryption key, the network ID, and the profile list stored in the IC card 1.

In step S242, the CPU 51 notifies the hard disk recorder 3 of the encrypted network ID, and requests the hard disk recorder 3 to send a stored content.

In step S261, the CPU 101 in the hard disk recorder 3 receives the information such as the network ID notified of by the television receiver 2. In step S262, the CPU 101 decrypts the network ID using the VPN encryption key stored in the hard disk recorder 3. In step S263, the CPU 101 determines whether the network ID is authentic.

If it is determined in step S263 that the network ID is unauthentic, the CPU 101 ends the process, else the CPU 101 proceeds to step S264. The CPU 101 produces a session key to transfer the content.

In step S265, the CPU 101 encrypts the produced session key using the VPN encryption key, and in step S266, the CPU 101 notifies the television receiver 2 of the encrypted session key.

In step S243, the CPU 51 in the television receiver 2 receives the encrypted session key. In step S244, the CPU 51 extracts the session key using the VPN encryption key, and stores it in the storage unit 58.

After notifying the television receiver 2 of the session key, the CPU 101 in the hard disk recorder 3 encrypts the content using the session key in step S267, and transfers the content to the television receiver 2 in step S268.

The television receiver 2 receives the content transferred from the hard disk recorder 3 through the VPN 5 in step S245. In step S246,the CPU 51 in the television receiver 2 decrypts the content using the session key stored in step S244, and then reproduces the content in step S247. The video processed by the television signal processor 59 is presented on the display 60 to the user.

In the above discussion, the user views the content, stored in the hard disk recorder 3, on the television receiver 2. The user can also replay the content on the PDA 4 that forms the same VPN with the hard disk recorder 3.

In this way, the user enjoys the content on an apparatus which is different from an apparatus to which the content is downloaded. Since the downloaded content is used on only an apparatus to which the IC card 1 is placed close (only an apparatus forming the VPN), unlimited copying of the content is controlled.

Once the user gets an IC card by registering the required information in the billing device 162, the user can purchase a content using the network ID of that IC card. The user is thus freed from an operation of inputting a variety of pieces of information each time the user purchases a content.

The information including the network ID and the profile list is shared in common among the apparatuses forming the VPN. However, if a network ID includes a plurality of ID's such as “a payment ID (an ID for performing a billing process)”, “a service utilization ID (an ID for utilizing a delivery service of a content from the content delivery server 161)”, and “a copyright management ID (an ID for preventing unrestricted copying)”, only a required ID may be shared.

For example, all ID's are transferred to an apparatus such as the television receiver 2 which assures security (being not accessed by an external apparatus), and only the “service utilization ID” is transferred to an apparatus such as a personal computer which is typically not perfectly secure. Based on the profiles of the apparatuses, the IC card 1 determines which ID to transfer to each apparatus. In this way, an unauthorized use of the “payment ID” by someone else is controlled.

The IC card uses the loop antenna to transfer power and data. Alternatively, the network ID and the profile list are shared in common by using IrDA (Infrared Data Association) or the combination of a bar code and a bar coder reader. This embodiment uses the IC card, but the present invention is not limited to the IC card. Alternatively, a module having any shape is perfectly acceptable as long as the module has the same function. The communication of the IC card is not limited to a non-contact type. The IC card communicates with each apparatus in a contact-type communication.

Each apparatus forming the VPN is identified using the IP address such as IPv6. Any type of information is used as long as the information is unique. Even if an IP address of IPv4 is assigned to each apparatus, identification information is uniquely assigned to each apparatus in the system. A server manages the association between the identification information and the IP address dynamically assigned to the identification. The identification information is sent to the server to query the IP address. An apparatus to which the IC card is placed close identifies apparatuses forming the VPN based on the identification information, and accesses the apparatuses.

The above series of process steps are performed using hardware. Alternatively, these process steps may be performed using software programs.

When the process steps are performed using a software program, a program code forming the software program may be installed in a computer assembled into a dedicated hardware, or a program code forming the software program may be installed from a network or a program storage medium to a general-purpose personal computer which performs a variety of functions.

The program storage medium may be a package medium which may be distributed separately from the apparatus to supply the user with the software programs as shown in FIG. 6. The package medium may be the magnetic disk 132 (such as a floppy disk), the optical disk 133 (such as a CD-ROM (Compact Disk-Read Only Memory) and a DVD (Digital Versatile Disk)), the magneto-optical disk 134 (such as an MD (Mini Disk) (Trademark) or the semiconductor memory 135. The storage medium also may be the ROM 122 or the hard disk contained in the storage unit 128, each of which is supplied in the mounted state thereof in the apparatus and has a computer program stored therewithin.

It is not necessary that the process steps describing the software program to perform a diversity of processes be chronologically performed in the order stated in each flow diagram. Several process steps may be performed in parallel or separately.

In this specification, the system refers to an entire system containing a plurality of apparatuses.

What is claimed is:

1. A communication apparatus comprising:
storage means which stores first feature information indicating a feature of the communication apparatus,
first transmitter means which transmits the first feature information stored in the storage means to an electronic device,
receiver means which receives second feature information indicating a feature of another communication apparatus, and identification information identifying the electronic device, transmitted from the electronic device,
second transmitter means which is connected to the other communication apparatus based on the second feature information received from the receiver means, and then transmits the first feature information to the other communication apparatus,
forming means which stores the second feature information and then forms a virtual private network with the other communication apparatus,
requesting means which notifies a first information processor, connected to the communication apparatus through a network, of the identification information, and requests the first information processor to transmit a predetermined content, and
acquisition means which acquires the content transmitted by the first information processor in response to the request from the requesting means,
wherein the content acquired by the acquisition means is shared with the other communication apparatus through the virtual private network formed by the forming means.

2. A communication apparatus according to claim 1, further comprising registering means which registers payment destination information relating to a destination of the payment for the content in a second information processor that manages the issue of the electronic device.

3. A communication apparatus according to claim 1, further comprising authentication means for authenticating the other communication apparatus based on encryption key information transmitted from the electronic device and then received by the receiver means and the identification information received by the receiver means, wherein the content is shared with the other communication apparatus authenticated by the authentication means.

4. A communication method comprising:
a step of storing first feature information indicating a feature of a communication apparatus,
a first transmitting step of transmitting the first feature information stored in the storing step to an electronic device,
a receiving step of receiving second feature information indicating a feature of another communication apparatus, and identification information identifying the electronic device, transmitted from the electronic device,
a second transmitting step of establishing a connection with the other communication apparatus based on the second feature information received in the receiving step, and transmitting the first feature information to the other communication apparatus,
a forming step of storing the second feature information and then forming a virtual private network with the other communication apparatus,
a requesting step of notifying a first information processor, connected to the communication apparatus through a network, of the identification information, and requesting the first information processor to transmit a predetermined content, and
an acquisition step of acquiring the content transmitted by the first information processor in response to the request in the requesting step,
wherein the content acquired in the acquisition step is shared with the other communication apparatus through the virtual private network formed in the forming step.

5. A storage medium storing a computer readable program, the program comprising:
a first acquisition control step of controlling the acquisition of stored first feature information indicating a feature of a communication apparatus,
a first transmission control step of controlling the transmission of the first feature information acquired in the first acquisition control step to an electronic device,
a reception control step of controlling the reception of second feature information indicating a feature of another communication apparatus, and identification information identifying the electronic device, transmitted from the electronic device,
a second transmission control step of establishing a connection with the other communication apparatus based on the second feature information received in the reception control step, and controlling the transmission of the first feature information to the other communication apparatus,
a formation control step of controlling the storage of the second feature information and controlling the formation of a virtual private network with the other communication apparatus,
a request control step of notifying a first information processor, connected to the communication apparatus through a network, of the identification information and controlling the request of the transmission of a predetermined content, and
a second acquisition control step of controlling the acquisition of the content transmitted from the first information processor in response to the request in the request control step,
wherein the content acquired in the second acquisition control step is shared with the other communication apparatus through the virtual private network formed in the formation control step.

6. A computer program comprising:
a first acquisition control step of controlling the acquisition of stored first feature information indicating a feature of a communication apparatus,
a first transmission control step of controlling the transmission of the first feature information acquired in the first acquisition control step to an electronic device,
a reception control step of controlling the reception of second feature information indicating a feature of another communication apparatus, and identification information identifying the electronic device, transmitted from the electronic device,
a second transmission control step of establishing a connection with the other communication apparatus based on the second feature information received in the reception control step, and controlling the transmission of the first feature information to the other communication apparatus,
a formation control step of controlling the storage of the second feature information and controlling the formation of a virtual private network with the other communication apparatus,
a request control step of notifying a first information processor, connected to the communication apparatus through the network, of the identification information and controlling the request of the transmission of a predetermined content, and
a second acquisition control step of controlling the acquisition of the content transmitted from the first information processor in response to the request in the request control step,
wherein the content acquired in the second acquisition control step is shared with the other communication apparatus through the virtual private network formed in the formation control step.

7. An information processing apparatus for managing the issue of an electronic device, comprising:
receiver means which receives payment destination information specifying a destination of the payment for a predetermined content acquired by a communication apparatus connected to the information processing apparatus through a network,
management means which manages the payment destination information received through the receiver means and identification information identifying the electronic device by associating the payment destination information with the identification information, and
billing means which acquires the payment destination information managed by the management means based on the identification information notified of by the communication apparatus and bills the charge for the content,
wherein the identification information is shared in a virtual private network including the communication apparatus and another communication apparatus when the electronic device is placed close to the communication apparatus.

8. An information processing method for managing the issue of an electronic device, comprising:
a receiving step of receiving payment destination information specifying a destination of the payment for a predetermined content acquired by a communication apparatus connected to the information processing apparatus through a network,
a management step of managing the payment destination information received in the receiving step and identification information identifying the electronic device by associating the payment destination information with the identification information, and
a billing step of acquiring the payment destination information managed by the management step based on the identification information notified of by the communication apparatus and billing the charge for the content,
wherein the identification information is shared in a virtual private network including the communication apparatus and another communication apparatus when the electronic device is placed close to the communication apparatus.

9. A storage medium, in an information processing apparatus for managing the issue of an electronic device, for storing a computer readable program, the program comprising;
a reception control step of controlling the reception of payment destination information specifying a destination of the payment for a predetermined content acquired by a communication apparatus connected through a network,
a management step of managing the payment destination information received in the reception control step and identification information identifying the electronic device by associating the payment destination information with the identification information, and
a billing step of acquiring the payment destination information managed in the management step based on the identification information notified of by the communication apparatus and billing the charge for the content,
wherein the identification information is shared in a virtual private network including the communication apparatus and another communication apparatus when the electronic device is placed close to the communication apparatus.

10. A computer program for a computer that controls an information processing apparatus for managing the issue of an electronic device, the computer program comprising:
a reception control step of controlling the reception of payment destination information specifying a destination of the payment for a predetermined content acquired by a communication apparatus connected through a network,
a management step of managing the payment destination information received in the reception control step and identification information identifying the electronic device by associating the payment destination information with the identification information, and
a billing step of acquiring the payment destination information managed in the management step based on the identification information notified of by the communication apparatus and billing the charge for the content,
wherein the identification information is shared in a virtual private network including the communication apparatus and another communication apparatus when the electronic device is placed close to the communication apparatus.
